(19) United States
(12) Patent Application Publication
(10) Pub. No.: US 2019/0236450 A1
(43) Pub. Date: Aug. 1, 2019

(54) MULTIMODAL MACHINE LEARNING SELECTOR

(71) Applicant: Snap Inc., Santa Monica, CA (US)

(72) Inventors: Yanen Li, Los Angeles, CA (US); Kuan Liu, Playa Vista, CA (US); Ning Xu, Irvine, CA (US)

(21) Appl. No.: 16/230,909

(22) Filed: Dec. 21, 2018

Related U.S. Application Data
(60) Provisional application No. 62/610,057, filed on Dec. 22, 2017.

(51) Int. Cl. G06N 3/08; G06N 3/04

(52) U.S. Cl. CPC G06N 3/08; G06N 3/04

(57) ABSTRACT

Multimodal data sets of a given entity (e.g., a user) can be processed using a plurality of different machine learning schemes, such as a recurrent neural network and a fully connected neural network. Representations generated by the networks can be combined in an additive layer and further in a multiplicative layer that emphasizes informative modalities and tolerates less informative modalities.

### CLAIM FOR PRIORITY

This application claims the benefit of priority to U.S. Application Ser. No. 62/610,057, filed Dec. 22, 2017, which is hereby incorporated by reference in its entirety.

### TECHNICAL FIELD

Embodiments of the present disclosure relate generally to machine learning and, more particularly, but not by way of limitation, to classifying multimodal data using neural networks.

### BACKGROUND

Different types of machine learning schemes can be used to generate characterizations of entities, such as a network site user. The different characterizations can be combined and input into a further machine learning scheme to generate a classification of a user. For example, a first machine learning scheme can analyze a user's profile image and a second machine learning scheme can analyze a user's profile data (e.g., text data), and a third machine learning scheme can generate a likelihood that the user is of a give category from the outputs of the first and second machine learning schemes. While different machine learning schemes can be used to analyze different types of data, combining them can create inaccuracies because some of the data generated by one or more of the machine learning schemes is noisy or non-informative.

### BRIEF DESCRIPTION OF THE DRAWINGS

To easily identify the discussion of any particular element or act, the most significant digit or digits in a reference number refer to the figure (“FIG.”) number in which that element or act is first introduced.

FIG. 1 is a block diagram showing an example messaging system for exchanging data (e.g., messages and associated content) over a network.

FIG. 2 is block diagram illustrating further details regarding a messaging system having an integrated virtual object machine learning system, according to example embodiments.

FIG. 3 is a schematic diagram illustrating data that may be stored in a database of a messaging server system, according to certain example embodiments.

FIG. 4 is a schematic diagram illustrating a structure of a message, according to some embodiments, generated by a messaging client application for communication.

FIG. 5 is a schematic diagram illustrating an example access-limiting process, in terms of which access to content (e.g., an ephemeral message, and associated multimedia payload of data) or a content collection (e.g., an ephemeral message story) may be time-limited (e.g., made ephemeral).

FIG. 6 shows example functional components of a multimodal classification system, according to some example embodiments.

FIG. 7A shows an architecture of a multimodal classification system, according to some example embodiments.

FIG. 7B shows a flow diagram of a method for implementing a multimodal classification system, according to some example embodiments.

FIG. 8 shows a flow diagram of a method for generating an ephemeral message using a multimodal classification system, according to some example embodiments.

FIG. 9 shows example user data in different modalities, according to some example embodiments.

FIGS. 10A and 10B show example ephemeral messages with content from the multimodal classification system, according to some example embodiments.

FIG. 11 is a block diagram illustrating a representative software architecture, which may be used in conjunction with various hardware architectures herein described.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

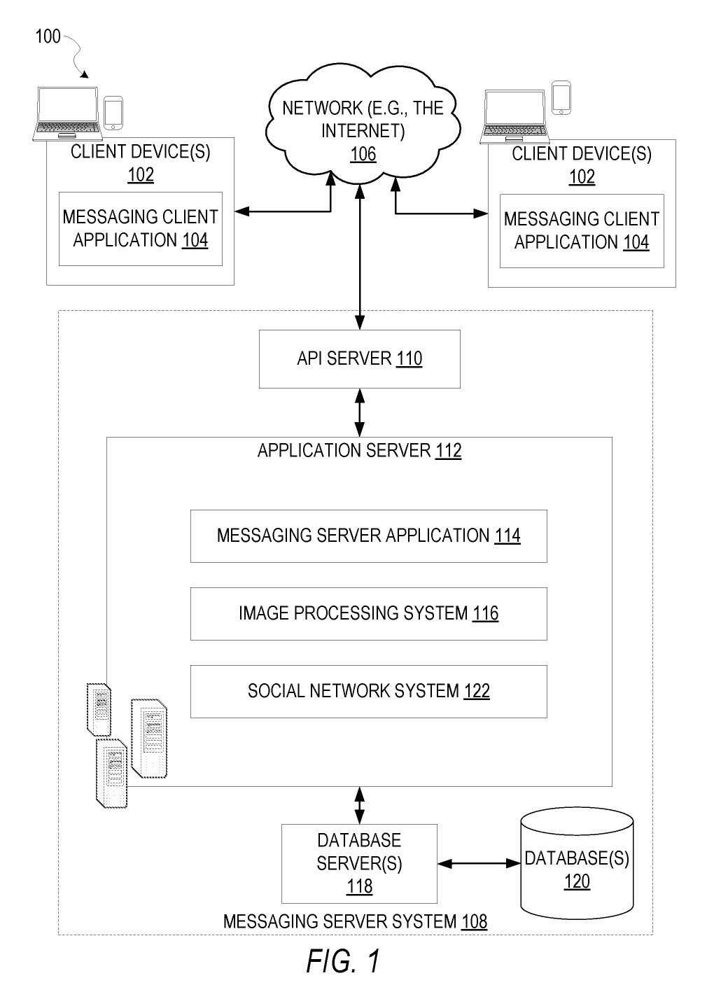

FIG. 1 is a block diagram showing an example messaging system 100 for exchanging data (e.g., messages and associated content) over a network. The messaging system 100 includes multiple client devices 102, each of which hosts a number of applications including a messaging client application 104. Each messaging client application 104 is communicatively coupled to other instances of the messaging client application 104 and a messaging server system 108 via a network 106 (e.g., the Internet).

Accordingly, each messaging client application 104 is able to communicate and exchange data with another messaging client application 104 and with the messaging server system 108 via the network 106. The data exchanged between messaging client applications 104, and between a messaging client application 104 and the messaging server system 108, includes functions (e.g., commands to invoke functions) as well as payload data (e.g., text, audio, video, or other multimedia data).

The messaging server system 108 provides server-side functionality via the network 106 to a particular messaging client application 104. While certain functions of the messaging system 100 are described herein as being performed by either a messaging client application 104 or by the messaging server system 108, it will be appreciated that the location of certain functionality within either the messaging client application 104 or the messaging server system 108 is a design choice. For example, it may be technically preferable to initially deploy certain technology and functionality within the messaging server system 108, and to later migrate this technology and functionality to the messaging client application 104 where a client device 102 has a sufficient processing capacity.

The messaging server system 108 supports various services and operations that are provided to the messaging client application 104. Such operations include transmitting data to, receiving data from, and processing data generated by the messaging client application 104. This data may include message content, client device information, geolocation information, media annotation and overlays, message content persistence conditions, social network information, and live event information, as examples. Data exchanges within the messaging system 100 are invoked and controlled through functions available via user interfaces (UIs) of the messaging client application 104.

Turning now specifically to the messaging server system 108, an application programming interface (API) server 110 is coupled to, and provides a programmatic interface to, an application server 112. The application server 112 is communicatively coupled to a database server 118, which facilitates access to a database 120 in which is stored data associated with messages processed by the application server 112.

The API server 110 receives and transmits message data (e.g., commands and message payloads) between the client devices 102 and the application server 112. Specifically, the API server 110 provides a set of interfaces (e.g., routines and protocols) that can be called or queried by the messaging client application 104 in order to invoke functionality of the application server 112. The API server 110 exposes various functions supported by the application server 112, including account registration; login functionality; the sending of messages, via the application server 112, from a particular messaging client application 104 to another messaging client application 104; the sending of media files (e.g., images or video) from a messaging client application 104 to a messaging server application 114 for possible access by another messaging client application 104; the setting of a collection of media data (e.g., a story); the retrieval of such collections; the retrieval of a list of friends of a user of a client device 102; the retrieval of messages and content; the adding and deletion of friends to and from a social graph; the location of friends within the social graph; and opening application events (e.g., relating to the messaging client application 104).

The application server 112 hosts a number of applications and subsystems, including the messaging server application 114, an image processing system 116, and a social network system 122. The messaging server application 114 implements a number of message-processing technologies and functions particularly related to the aggregation and other processing of content (e.g., textual and multimedia content) included in messages received from multiple instances of the messaging client application 104. As will be described in further detail, the text and media content from multiple sources may be aggregated into collections of content (e.g., called stories or galleries). These collections are then made available, by the messaging server application 114, to the messaging client application 104. Other processor- and memory-intensive processing of data may also be performed server-side by the messaging server application 114, in view of the hardware requirements for such processing.

The application server 112 also includes the image processing system 116, which is dedicated to performing various image processing operations, typically with respect to images or video received within the payload of a message at the messaging server application 114.

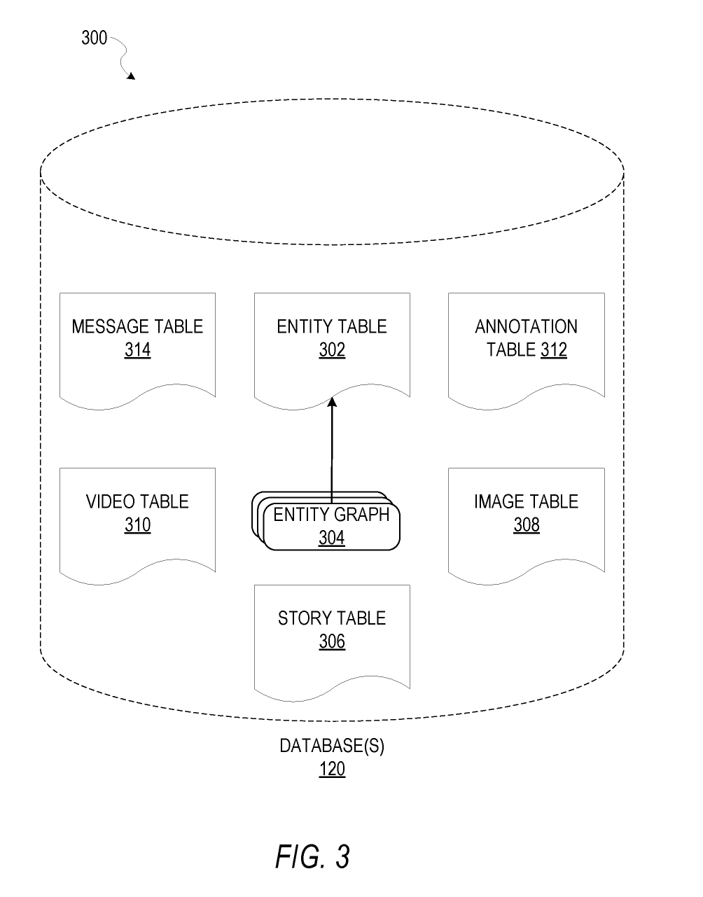

The social network system 122 supports various social networking functions and services, and makes these functions and services available to the messaging server application 114. To this end, the social network system 122 maintains and accesses an entity graph (e.g., entity graph 304 in FIG. 3) within the database 120. Examples of functions and services supported by the social network system 122 include the identification of other users of the messaging system 100 with whom a particular user has relationships or whom the particular user is “following,” and also the identification of other entities and interests of a particular user.

The application server 112 is communicatively coupled to a database server 118, which facilitates access to a database 120 in which is stored data associated with messages processed by the messaging server application 114.

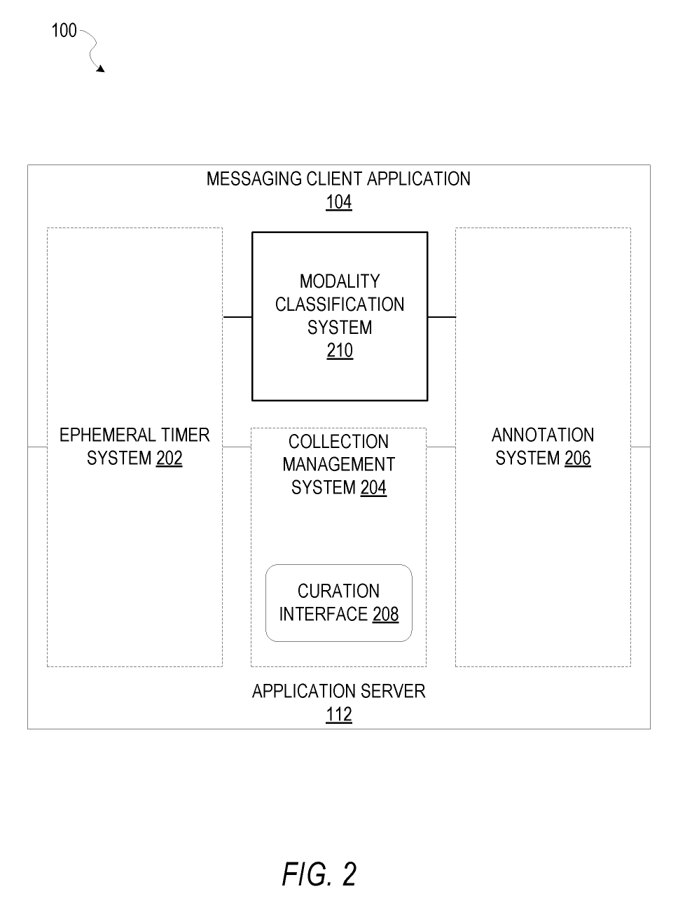

FIG. 2 is block diagram illustrating further details regarding the messaging system 100, according to example embodiments. Specifically, the messaging system 100 is shown to comprise the messaging client application 104 and the application server 112, which in turn embody a number of subsystems, namely an ephemeral timer system 202, a collection management system 204, an annotation system 206, and multimodal classification system 210.

The ephemeral timer system 202 is responsible for enforcing the temporary access to content permitted by the messaging client application 104 and the messaging server application 114. To this end, the ephemeral timer system 202 incorporates a number of timers that, based on duration and display parameters associated with a message or collection of messages (e.g., a story), selectively display and enable access to messages and associated content via the messaging client application 104. Further details regarding the operation of the ephemeral timer system 202 are provided below.

The collection management system 204 is responsible for managing collections of media (e.g., collections of text, image, video, and audio data). In some examples, a collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client application 104.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain embodiments, compensation may be paid to a user for inclusion of user-generated content into a collection. In such cases, the curation interface 208 operates to automatically make payments to such users for the use of their content.

The annotation system 206 provides various functions that enable a user to annotate or otherwise modify or edit media content associated with a message. For example, the annotation system 206 provides functions related to the generation and publishing of media overlays for messages processed by the messaging system 100. The annotation system 206 operatively supplies a media overlay (e.g., a Geofilter or filter) to the messaging client application 104 based on a geolocation of the client device 102. In another example, the annotation system 206 operatively supplies a media overlay to the messaging client application 104 based on other information, such as social network information of the user of the client device 102. A media overlay may include audio and visual content and visual effects. Examples of audio and visual content include pictures, text, logos, animations, and sound effects. An example of a visual effect includes color overlaying. The audio and visual content or the visual effects can be applied to a media content item (e.g., a photo) at the client device 102. For example, the media overlay includes text that can be overlaid on top of a photograph generated by the client device 102. In another example, the media overlay includes an identification of a location (e.g., Venice Beach), a name of a live event, or a name of a merchant (e.g., Beach Coffee House). In another example, the annotation system 206 uses the geolocation of the client device 102 to identify a media overlay that includes the name of a merchant at the geolocation of the client device 102. The media overlay may include other indicia associated with the merchant. The media overlays may be stored in the database 120 and accessed through the database server 118.

In one example embodiment, the annotation system 206 provides a user-based publication platform that enables users to select a geolocation on a map and upload content associated with the selected geolocation. The user may also specify circumstances under which particular content should be offered to other users. The annotation system 206 generates a media overlay that includes the uploaded content and associates the uploaded content with the selected geolocation.

In another example embodiment, the annotation system 206 provides a merchant-based publication platform that enables merchants to select a particular media overlay associated with a geolocation via a bidding process. For example, the annotation system 206 associates the media overlay of a highest-bidding merchant with a corresponding geolocation for a predefined amount of time.

FIG. 3 is a schematic diagram illustrating data 300 which may be stored in the database 120 of the messaging server system 108, according to certain example embodiments. While the content of the database 120 is shown to comprise a number of tables, it will be appreciated that the data could be stored in other types of data structures (e.g., as an object-oriented database).

The database 120 includes message data stored within a message table 314. An entity table 302 stores entity data, including an entity graph 304. Entities for which records are maintained within the entity table 302 may include individuals, corporate entities, organizations, objects, places, events, and so forth. Regardless of type, any entity regarding which the messaging server system 108 stores data may be a recognized entity. Each entity is provided with a unique identifier, as well as an entity type identifier (not shown).

The entity graph 304 furthermore stores information regarding relationships and associations between or among entities. Such relationships may be social, professional (e.g., work at a common corporation or organization), interest-based, or activity-based, for example.

The database 120 also stores annotation data, in the example form of filters, in an annotation table 312. Filters for which data is stored within the annotation table 312 are associated with and applied to videos (for which data is stored in a video table 310) and/or images (for which data is stored in an image table 308). Filters, in one example, are overlays that are displayed as overlaid on an image or video during presentation to a recipient user. Filters may be of various types, including user-selected filters from a gallery of filters presented to a sending user by the messaging client application 104 when the sending user is composing a message. Other types of filters include geolocation filters (also known as geo-filters), which may be presented to a sending user based on geographic location. For example, geolocation filters specific to a neighborhood or special location may be presented within a user interface by the messaging client application 104, based on geolocation information determined by a Global Positioning System (GPS) unit of the client device 102. Another type of filter is a data filter, which may be selectively presented to a sending user by the messaging client application 104, based on other inputs or information gathered by the client device 102 during the message creation process. Examples of data filters include a current temperature at a specific location, a current speed at which a sending user is traveling, a battery life for a client device 102, or the current time.

Other annotation data that may be stored within the image table 308 is so-called “lens” data. A “lens” may be a real-time special effect and sound that may be added to an image or a video.

As mentioned above, the video table 310 stores video data which, in one embodiment, is associated with messages for which records are maintained within the message table 314. Similarly, the image table 308 stores image data associated with messages for which message data is stored in the message table 314. The entity table 302 may associate various annotations from the annotation table 312 with various images and videos stored in the image table 308 and the video table 310.

A story table 306 stores data regarding collections of messages and associated image, video, or audio data, which are compiled into a collection (e.g., a story or a gallery). The creation of a particular collection may be initiated by a particular user (e.g., each user for whom a record is maintained in the entity table 302). A user may create a “personal story” in the form of a collection of content that has been created and sent/broadcast by that user. To this end, the user interface of the messaging client application 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices 102 have location services enabled and are at a common location or event at a particular time may, for example, be presented with an option, via a user interface of the messaging client application 104, to contribute content to a particular live story. The live story may be identified to the user by the messaging client application 104 based on his or her location. The end result is a “live story” told from a community perspective.

A further type of content collection is known as a “location story,” which enables a user whose client device 102 is located within a specific geographic location (e.g., on a college or university campus) to contribute to a particular collection. In some embodiments, a contribution to a location story may require a second degree of authentication to verify that the end user belongs to a specific organization or other entity (e.g., is a student on the university campus).

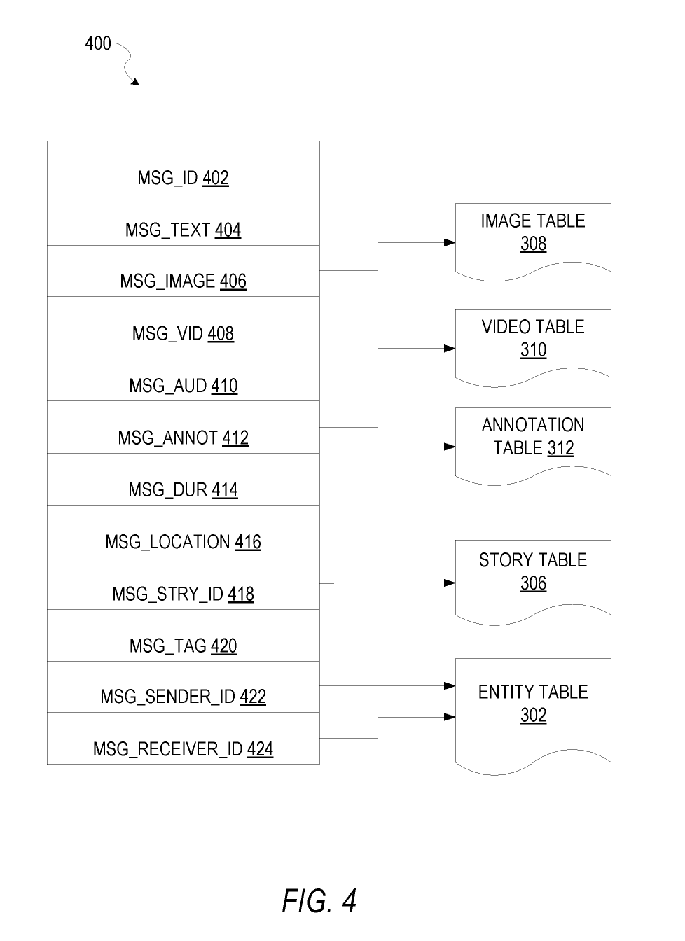

FIG. 4 is a schematic diagram illustrating a structure of a message 400, according to some embodiments, generated by a messaging client application 104 for communication to a further messaging client application 104 or the messaging server application 114. The content of a particular message 400 is used to populate the message table 314 stored within the database 120, accessible by the messaging server application 114. Similarly, the content of a message 400 is stored in memory as “in-transit” or “in-flight” data of the client device 102 or the application server 112. The message 400 is shown to include the following components:
A message identifier 402: a unique identifier that identifies the message 400.
A message text payload 404: text, to be generated by a user via a user interface of the client device 102, and that is included in the message 400.
A message image payload 406: image data captured by a camera component of a client device 102 or retrieved from memory of a client device 102, and that is included in the message 400.
A message video payload 408: video data captured by a camera component or retrieved from a memory component of the client device 102, and that is included in the message 400.
A message audio payload 410: audio data captured by a microphone or retrieved from the memory component of the client device 102, and that is included in the message 400.
Message annotations 412: annotation data (e.g., filters, stickers, or other enhancements) that represents annotations to be applied to the message image payload 406, message video payload 408, or message audio payload 410 of the message 400.
A message duration parameter 414: a parameter value indicating, in seconds, the amount of time for which content of the message 400 (e.g., the message image payload 406, message video payload 408, and message audio payload 410) is to be presented or made accessible to a user via the messaging client application 104.
A message geolocation parameter 416: geolocation data (e.g., latitudinal and longitudinal coordinates) associated with the content payload of the message 400. Multiple message geolocation parameter 416 values may be included in the payload, with each of these parameter values being associated with respective content items included in the content (e.g., a specific image in the message image payload 406, or a specific video in the message video payload 408).
A message story identifier 418: identifies values identifying one or more content collections (e.g., “stories”) with which a particular content item in the message image payload 406 of the message 400 is associated. For example, multiple images within the message image payload 406 may each be associated with multiple content collections using identifier values.
A message tag 420: one or more tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
A message sender identifier 422: an identifier (e.g., a messaging system identifier, email address, or device identifier) indicative of a user of the client device 102 on which the message 400 was generated and from which the message 400 was sent.
A message receiver identifier 424: an identifier (e.g., a messaging system identifier, email address, or device identifier) indicative of a user of the client device 102 to which the message 400 is addressed.

The contents (e.g., values) of the various components of the message 400 may be pointers to locations in tables within which content data values are stored. For example, an image value in the message image payload 406 may be a pointer to (or address of) a location within the image table 308. Similarly, values within the message video payload 408 may point to data stored within the video table 310, values stored within the message annotations 412 may point to data stored in the annotation table 312, values stored within the message story identifier 418 may point to data stored in the story table 306, and values stored within the message sender identifier 422 and the message receiver identifier 424 may point to user records stored within the entity table 302.

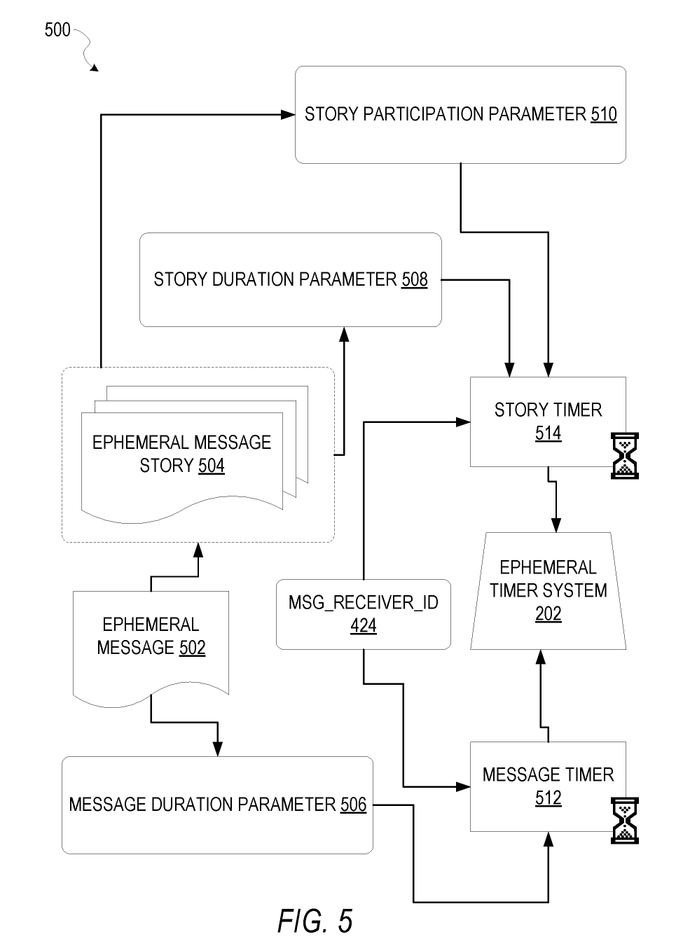

FIG. 5 is a schematic diagram illustrating an access-limiting process 500, in terms of which access to content (e.g., an ephemeral message 502, and associated multimedia payload of data) or a content collection (e.g., an ephemeral message story 504) may be time-limited (e.g., made ephemeral).

An ephemeral message 502 is shown to be associated with a message duration parameter 506, the value of which determines an amount of time that the ephemeral message 502 will be displayed to a receiving user of the ephemeral message 502 by the messaging client application 104. In one embodiment, where the messaging client application 104 is an application client, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 512, which is responsible for determining the amount of time that the ephemeral message 502 is shown to a particular receiving user identified by the message receiver identifier 424. In particular, the ephemeral message 502 will only be shown to the relevant receiving user for a time period determined by the value of the message duration parameter 506. The message timer 512 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message story 504 (e.g., a personal story, or an event story). The ephemeral message story 504 has an associated story duration parameter 508, a value of which determines a time duration for which the ephemeral message story 504 is presented and accessible to users of the messaging system 100. The story duration parameter 508, for example, may be the duration of a music concert, where the ephemeral message story 504 is a collection of content pertaining to that concert. Alternatively, a user (either the owning user or a curator user) may specify the value for the story duration parameter 508 when performing the setup and creation of the ephemeral message story 504.

Additionally, each ephemeral message 502 within the ephemeral message story 504 has an associated story participation parameter 510, a value of which determines the duration of time for which the ephemeral message 502 will be accessible within the context of the ephemeral message story 504. Accordingly, a particular ephemeral message 502 may “expire” and become inaccessible within the context of the ephemeral message story 504, prior to the ephemeral message story 504 itself expiring in terms of the story duration parameter 508. The story duration parameter 508, story participation parameter 510, and message receiver identifier 424 each provide input to a story timer 514, which operationally determines whether a particular ephemeral message 502 of the ephemeral message story 504 will be displayed to a particular receiving user and, if so, for how long. Note that the ephemeral message story 504 is also aware of the identity of the particular receiving user as a result of the message receiver identifier 424.

Accordingly, the story timer 514 operationally controls the overall lifespan of an associated ephemeral message story 504, as well as an individual ephemeral message 502 included in the ephemeral message story 504. In one embodiment, each and every ephemeral message 502 within the ephemeral message story 504 remains viewable and accessible for a time period specified by the story duration parameter 508. In a further embodiment, a certain ephemeral message 502 may expire, within the context of the ephemeral message story 504, based on a story participation parameter 510. Note that a message duration parameter 506 may still determine the duration of time for which a particular ephemeral message 502 is displayed to a receiving user, even within the context of the ephemeral message story 504. Accordingly, the message duration parameter 506 determines the duration of time that a particular ephemeral message 502 is displayed to a receiving user, regardless of whether the receiving user is viewing that ephemeral message 502 inside or outside the context of an ephemeral message story 504.

The ephemeral timer system 202 may furthermore operationally remove a particular ephemeral message 502 from the ephemeral message story 504 based on a determination that it has exceeded an associated story participation parameter 510. For example, when a sending user has established a story participation parameter 510 of 24 hours from posting, the ephemeral timer system 202 will remove the relevant ephemeral message 502 from the ephemeral message story 504 after the specified 24 hours. The ephemeral timer system 202 also operates to remove an ephemeral message story 504 either when the story participation parameter 510 for each and every ephemeral message 502 within the ephemeral message story 504 has expired, or when the ephemeral message story 504 itself has expired in terms of the story duration parameter 508.

In certain use cases, a creator of a particular ephemeral message story 504 may specify an indefinite story duration parameter 508. In this case, the expiration of the story participation parameter 510 for the last remaining ephemeral message 502 within the ephemeral message story 504 will determine when the ephemeral message story 504 itself expires. In this case, a new ephemeral message 502, added to the ephemeral message story 504, with a new story participation parameter 510, effectively extends the life of an ephemeral message story 504 to equal the value of the story participation parameter 510.

In response to the ephemeral timer system 202 determining that an ephemeral message story 504 has expired (e.g., is no longer accessible), the ephemeral timer system 202 communicates with the messaging system 100 (e.g., specifically, the messaging client application 104) to cause an indicium (e.g., an icon) associated with the relevant ephemeral message story 504 to no longer be displayed within a user interface of the messaging client application 104. Similarly, when the ephemeral timer system 202 determines that the message duration parameter 506 for an ephemeral message 502 has expired, the ephemeral timer system 202 causes the messaging client application 104 to no longer display an indicium (e.g., an icon or textual identification) associated with the ephemeral message 502.

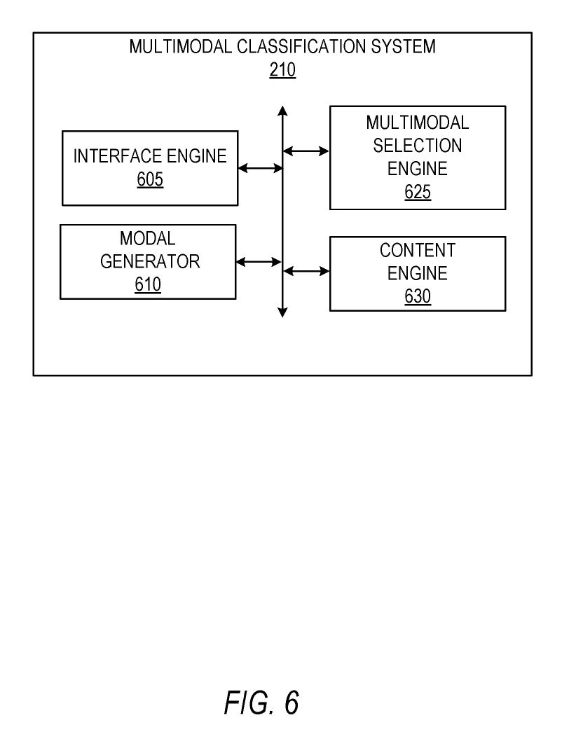

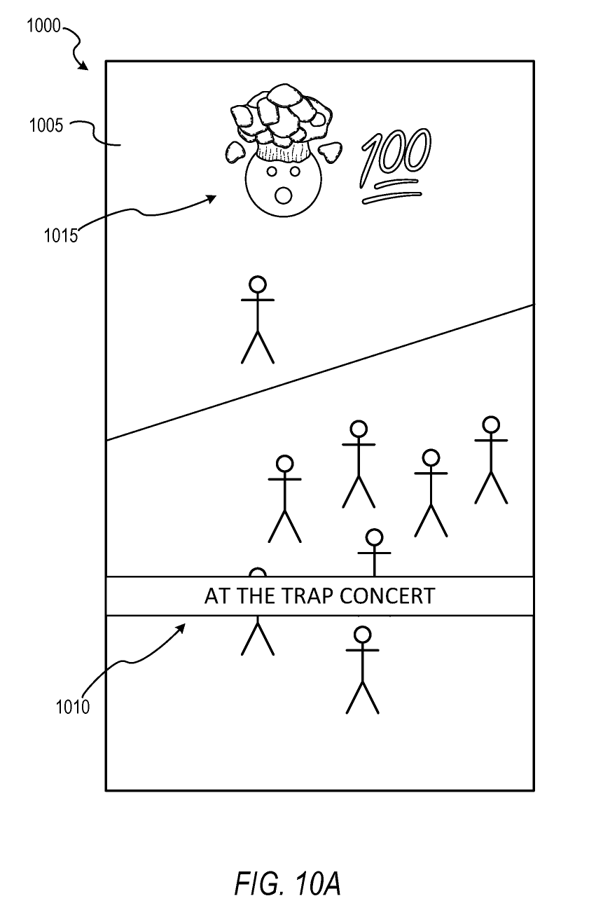

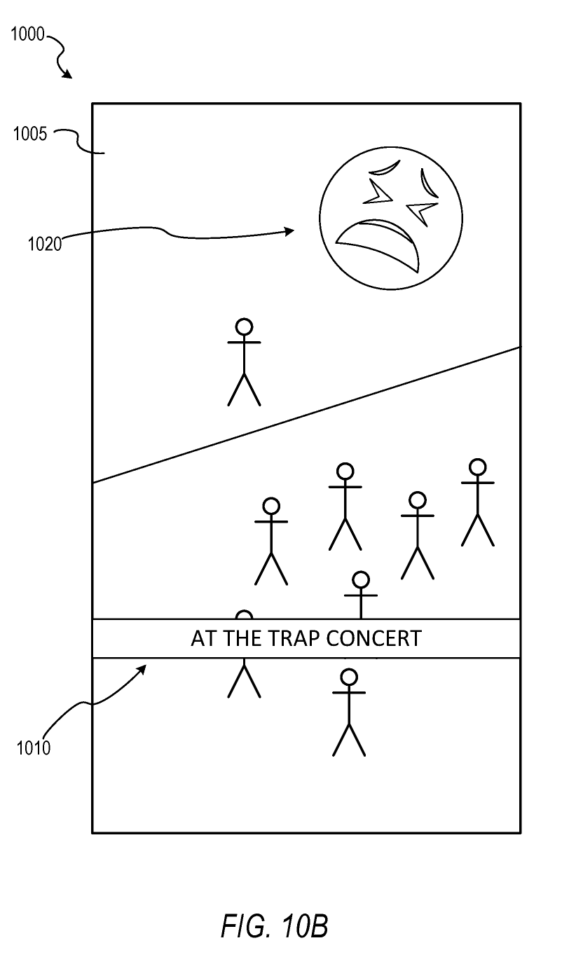

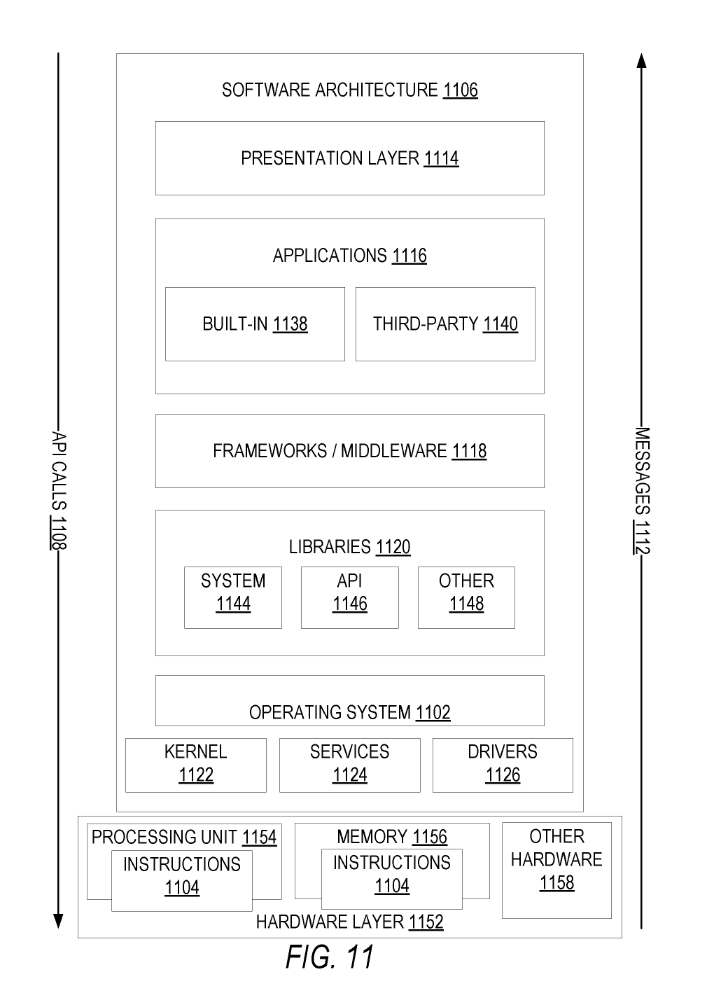

FIG. 6 shows example functional components of a multimodal classification system 210, according to some example embodiments. As illustrated, the multimodal classification system 210 comprises an interface engine 605, a modal generator 610, a multimodal selection engine 625, and a content engine. The interface engine 605 manages generating user interface content for interaction with a user of a client device. For example, the interface engine 605 can display an ephemeral message comprising an image generated on the client device and an accompanying caption input by the user that describes the image. The interface engine 605 can further receive content (e.g., from content engine 630) for display to the user, such as overlay content as described in further detail with reference to FIGS. 10 and 11 below.

The modal generator 610 is responsible for generating representations of user data in different modalities. As used here, a representation is an input or output of a machine learning scheme (e.g., a neural network). Examples of representations include: vectors, tensors, embeddings, features and other numerical descriptions of data processed or generated by machine learning schemes, as is appreciated by those having ordinary skill in the art of machine learning. The modal generator 610 comprises multiple type of machine learning schemes or “generators”, such as a convolutional neural network to generate data in a visual modality, recurrent neural networks to generate data in a recurrent text modality (e.g., bidirectional modality, unidirectional modality, deep or fully connected networks to generate further text modalities, and so on. Each modality is a representation of the user's data in a different mode. For example, a modal generator 610 can include a convolutional neural network that receives a user profile data as an input and generates a visual image vector. Further, the modal generator 610 can include a deep neural network configured generate a user profile data using profile data from a user's profile. Further, the modal generator 610 can include another deep neural network that generates a representation of the user's friend network, and a further deep neural network that generates further representation of the user's social network site posts, and so on.

Each of the different types of modalities generated can be input into the multimodal selection engine 625, which attenuates weak/noisy modalities and emphasizes strong/informative modalities. The multimodal selection engine 625 can be configured for different machine learning tasks in which a prediction is output from different modal inputs. For example, the multimodal selection engine 625 can receive a visual vector generated from a user's profile picture, post data vector generated from the user's social media posts, and a profile vector generated from the user's profile data and generate a likelihood that the user is over or under 45 years of age, or generate a likelihood that the primary sex (e.g., gender) of the user is female or male. The data output by the multimodal selection engine 625 can be used by the content engine 630 to select content for display to the user. The user can optionally select the data to include it in a social media post (e.g., ephemeral message 504).

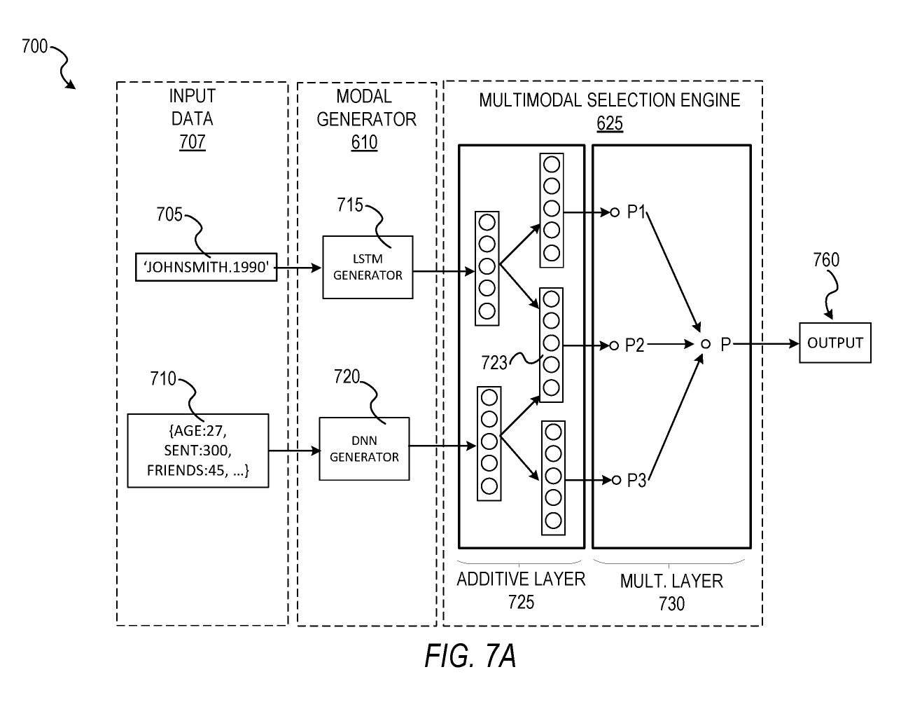

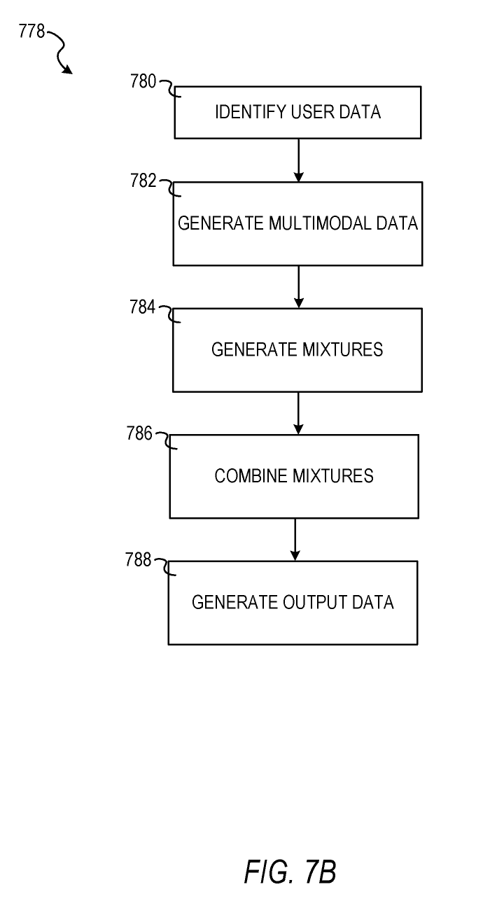

FIG. 7 shows an example architecture 700 of the multimodal selection engine 625, according to some example embodiments. At a high-level, input data 707 of different modalities is input into different generators of the modal generator 610 to generate vector representations of the different modalities. The multimodal selection engine 625 comprises an additive layer 725 that generates different mixtures of the different modalities and multiplicative layer 730 that selects the best performing modalities. The additive layer 725 and the multiplicative layer 730 function in concert to emphasize the good modalities (e.g., informative vector representations or mixtures thereof) and deemphasize bad modalities (e.g., non-informative or noisy vector representations or mixtures thereof) to generate output data 760.

In the below discussion, M indicates the number of modalities available in total. Each input modality (e.g., signal) is denoted as a dense vector vₘ∈R^{dm}, ∀ₘ=1, 2, . . . , M. For example, given M=3 modalities in the user profiling task, v₁ is the profile image (represented as a vector), v₂ is the posted text representation, and v₃ encodes the friend network information. Further, according to some example embodiments, a K-way classification setting is implemented, where y denotes the labels, p^{k}ₘ denotes the prediction probability of the kth class from the mth modality, and p^{k} denotes the model's final prediction probability of the kth class. Further, superscripts are used with indices to denote classes and subscripts are used to denote modalities.

### Multimodal Deep Learning

As mentioned, neural networks can perform multimodal deep learning in multiple domains such as visual, audio, and text. The domain-specific neural networks are used on different modalities to generate their representations, and the individual representations can be merged or aggregated. A prediction can be made from the aggregated representations, and in some cases an additional neural network is implemented to capture interactions between modalities and learn complex function mapping between input and output. In some example embodiments, addition (or average) and concatenation are two approaches for aggregation.

u=Σₘfₘ(vₘ) [Eq. 1]

or

u=[f₁(v₁), . . . ,f₁(vₘ)] [Eq. 2]

where f is considered a domain specific neural network and fₘ: R^{dm}→R^{d}(m=1, . . . , M). Given the combined vector output u∈R^{d}, another network g computes the final output.

p=g(u) where g:R^{d}→R^{K} [Eq. 3]

The network structure is illustrated in the additive layer 725 of FIG. 7. The arrows are function mappings or computing operations. The dotted boxes are representations of single and combined modality features (combined feature 723). They are referred to as additive combinations because their critical step is to add modality hidden vectors.

In some example embodiments, additive approaches do not make assumptions regarding the reliability of different modality inputs. As such, additive approach performance relies on a single network, g, to figure out the relative emphasis to be placed on different modalities. From a modeling perspective, the aim is to recover the function mapping between the combined representation u and the desired outputs. This function can be complex in real scenarios. For instance, when the signals are similar or complementary to each other, g is supposed to merge them to make a strengthened decision; when signals conflict with each other, g should filter out the unreliable ones and make a decision based primarily on more reliable modalities. While in theory g has the capability to recover an arbitrary function given a sufficiently large amount of data, it can be in practice very difficult to train and regularize given data constraints in real applications. As a result, model performance can degrade significantly.

To this end, the multimodal classification system 210 is configured with an assumption that some modalities are not as informative as others on a particular sample. As a result, they should not be used for network training. Here modalities are differentiated as informative and good, or non-informative and weak. Continuing, let every modality make its own independent decision with its modal-specific model (e.g., pᵢ=gᵢ(vᵢ)) Their decisions are combined by taking an average using the following initial objective function,

L_{ce}= [symbol] ^{y}_{ce}, [symbol] ^{y}_{ce}=−Σᵢ₌₁^{M} log pᵢ^{y} [Eq. 4]

where y denotes the true class index, and [symbol] ^{y} is class loss (as it is part of the loss function associated with a particular class). In the testing stage, the model predicts the class with the smallest class loss:

ŷ=arg min_{y} [symbol] _{ce}^{y} [Eq. 5]

This approach trains one model per modality. However, when weak modalities exist, the objective of Eq. 4 significantly increases. By minimizing the objective of Eq. 4, it forces every model (based on its modality) to perform well on the training data. This could lead to severe overfitting as the noisy modality simply does not contain the information required to make a correct prediction, but the loss function penalizes it heavily for incorrect predictions.

### Combining in a Multiplicative Approach

To mitigate against the problem of overfitting, the multimodal selection engine 625 implements a multiplicative mechanism (multiplicative layer 730) to suppress the penalty incurred on noisy signals from certain modalities. A cost on a modality is down-weighted when there are other good modalities for this example. In some example embodiments, a modality is good (or bad) when it assigns a high (or low) probability to the correct class. A higher probability indicates more informative signals and stronger confidence. With that in mind, a down-weighting factor is implemented as follows:

qᵢ=[Π_{j≠i}(1−pⱼ)]^{β/(M-1)} [Eq. 6]

where the class index superscripts on p and q are omitted for brevity; β is a hyper parameter to control the strength of down-weighting and can be chosen by cross-validation. The new training criterion becomes:

L_{ce}= [symbol] ^{y}_{ce}, [symbol] ^{y}_{ce}=−Σᵢ₌₁^{M}qᵢ^{y} log pᵢ^{y} [Eq. 7]

The scaling factor [Π_{j≠i}(1−pⱼ)]^{β/(M-1)} represents the average prediction quality of the remaining modalities. This term is close to 0 when some p^{j} are close to 1. When those modalities (j≠i) have confident predictions on the correct class, the term has a small value, thus suppressing the cost on the current modality (pᵢ). When other modalities are already good, the current modality (pᵢ) does not have to be equally good. This down-weighting reduces the training requirement on all modalities and reduces overfitting. The hyper-parameter β to controls the strength of the modalities: larger values give a stronger suppressing effect and vice versa. During testing, a similar criterion in of Eq. 5 is implemented in which [symbol] _{ce} is replaced with [symbol] ₘᵤₗ. This approach is referred to as a multiplicative combination due to the use of multiplicative operations in Eq. 6.

The training process using multiplicative combination attempts to select some modalities that give the correct prediction and tolerate mistakes made by other modalities. This tolerance encourages each modality to work best in its own area (e.g., best sample) instead of on all sample data. It is emphasized that β implements a trade-off between ensemble and non-smoothed multiplicative combination. When β=0, then q=1.0 and predictions from different modalities are averaged; when β=1, there is no smoothing on (1−pⱼ) terms so that a good modality will strongly down-weight losses from other modalities. The proposed combination can be implemented as the last layer of a combination neural network as it is differentiable. Errors in Eq. 7 can be back-propagated to different components of the model such that the model can be trained jointly.

### Boosted Multiplicative Training

Despite providing a mechanism to selectively combine good and bad modalities, the multiplicative layer 730 as configured above can have limitations. For instance, when implementing Eq. 7, the multimodal selection engine 625 may stop minimizing the class losses on the correct classes when it is still incorrect; or in an alternative case, the multimodal selection engine 625 may attempt to reduce the class loss when the predictions are already correct.

To this end, a boosting extension is integrated into the objective function in Eq. 7, according to some example embodiments. Rather than always placing a loss on the correct class, a penalty is incurred only when the class loss values are not the smallest among all the classes. This approach creates a connection to the prediction mechanism in Eq. 5. If the prediction is correct, there is no need to further reduce the class loss on that instance; if the prediction is wrong, the class loss should be reduced even if the loss value is already relatively small. To increase robustness, a margin formulation is added, where the loss on the correct class should be smaller by a margin. Thus, the objective function becomes:

L= [symbol] ^{y}(1−Π_{∀y′≠y}1( [symbol] ₘᵤₗ^{y}+δ< [symbol] ₘᵤₗ^{y′})) [Eq. 8]

where the bracket part in the right-hand side of Eq. 8 computes whether the loss associated with the correct class is the smallest (by a margin). The margin δ is chosen in experiment by cross validation. The new objective function of Eq. 8 only aims to minimize the class losses which still need improvement. For those examples that already have correct classification, the loss is counted as zero. Therefore, the objective of Eq. 8 only adjusts the losses that lead to wrong prediction. In this way, model training and desired prediction accuracy are better aligned.

### Select Modality Mixtures

The multiplicative layer 730 explicitly assumes some modalities are noisy and is automatically configured to select good informative modalities. One limitation is that the models gᵢ (i=1, . . . , M) are trained primarily based on a single modality, although they do receive back-propagated errors from the other modalities through joint training. This can prevent this approach from fully capturing synergies across modalities. For example, in a given social network website, a user's follower network and followee network are two modalities that are different but closely related. They jointly contribute to predictions concerning the user's interests, etc. A purely multiplicative combination (e.g., where additive layer 725 is not implemented) would not be ideal in capturing such correlations. On the other hand, additive methods are able to capture model correlation more easily by design, although as discussed, the additive approaches do not explicitly handle modality noise and conflicts.

### Modality Mixture Candidates

The example embodiment of the multimodal selection engine 625 in FIG. 7 is configured to (1) capture all possible interactions between different modalities and (2) to filter out noises and pick useful signals. In order to be able to model interactions of different modalities, the additive layer 725 creates different mixtures of modalities. Particularly, the additive layer 725 enumerates all possible mixtures from the power set of the set of modality features. On each mixture, the additive layer 725 applies the additive operation to extract higher-level feature representations as follows:

u_{c}=Σ_{k∈M}_{_{c}}_{;M}_{_{c}}_{∈{1,2, . . . ,M}}f(vₖ) [Eq. 9]

where M_{c} contains one or more modalities. Thus, we have u_{c} as the representation of the mixture of modalities in set M_{c}. It gathers signals from all the modalities in M_{c}. Since there are 2^{M}−1 different non-empty M_{c}, there are 2^{M}−1 u_{c}, and each u_{c} looks into the mix of a different modality mixture. Each u_{c} is referred to as a mixture candidate because not every mixture is equally useful; some mixtures may be very helpful to model training while others are not and could in fact be harmful.

Given the generated candidate mixtures, predictions are made based on each of candidates independently. In particular, the additive layer 725 implements a neural network to make prediction p_{c} as follows,

p_{c}=g_{c}(u_{c}) [Eq. 10]

where p_{c} is the prediction result from an individual mixture. Different p_{c}'s may not agree with each other. The multiplicative layer 730 then handles selecting which mixture as useful or informative and how to combine them, as discussed below.

### Mixture Selections

The multiplicative layer 730 determines which mixtures of modalities are strong and which are weak, according to some example embodiments. In particular, the multiplicative layer 730 is configured to integrate Eq. 7 with the selection of mixture candidates in of Eq. 10, as follows:

[symbol]

^{y}=Σ_{c=1}^{|M}^{_{c}}^{|}q_{c}^{y} log p_{c}^{y} [Eq. 11]

where q_{c} is defined similarly. Eq. 11 follows from Eq. 7 except that each model here is based on a mixture candidate instead of a single modality.

FIG. 7B shows an example flow diagram of a method 778, of implementing the architecture 700 of FIG. 7A. At operation 780, the interface engine 605 identifies input data, such as user name 705 and user profile data 710. At operation 782, the modal generator 610 generates multimodal data. For example, the LSTM generator 715 generates a first data modality from user name 705 and the DNN generator 720 generates a second data modality from the user profile data 710.

At operation 784, the additive layer 725 additively creates modality mixture candidates (e.g., predictions of mixtures). The modality mixture candidates can be features from one single modality and can also be mixed features from multiple modalities. These candidates make it more straightforward to consider signal correlation and complementariness across modalities. However, it is unknown which candidate is good for a use case, as some candidates can be redundant and noisy.

At operation 786, the multiplicative layer 730 combines the prediction of different mixtures multiplicatively. The multiplicative layer 730 enables candidate selection in an automatic way where strong candidates are picked while weak ones are ignored (e.g., nulled, attenuated) without dramatically increasing the entire objective function. At operation 788, the multimodal selection engine 625 generates output data 760 (e.g., a prediction whether the user is over 45 or under 45 years of age). In this way, the model can pick the most useful modalities and modality mixtures with respect to our prediction task.

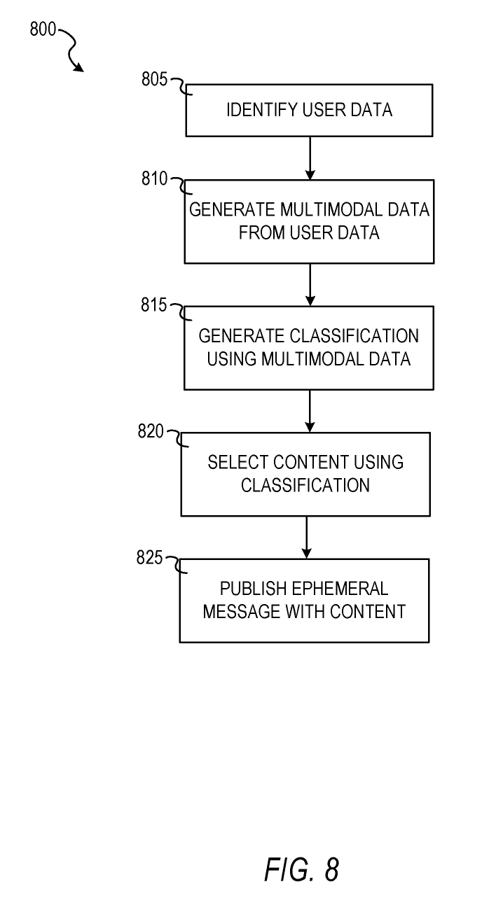

FIG. 8 shows a flow diagram 800 for generating an ephemeral message using the modality refinement system, according to some example embodiments. At operation 805, the interface engine 605 identifies user data (e.g., profile image, follower network, followee network, posts, etc.). At operation 810, the modal generator 610 generates multimodal data, such as vectors in different modalities. At operation 815, the multimodal selection engine 625 generates a classification of the user. For example, the multimodal selection engine 625 uses an additive layer and multiplicative layer to select and use informative modalities to predict whether the user is above or below 45 years of age. At operation 820, the content engine 630 selects content (e.g., text, pictorial symbols such as emojis) based on the classification of the user output from the multimodal selection engine 625. At operation 825, the interface engine 605 publishes an ephemeral message with the content selected by the content engine 630.

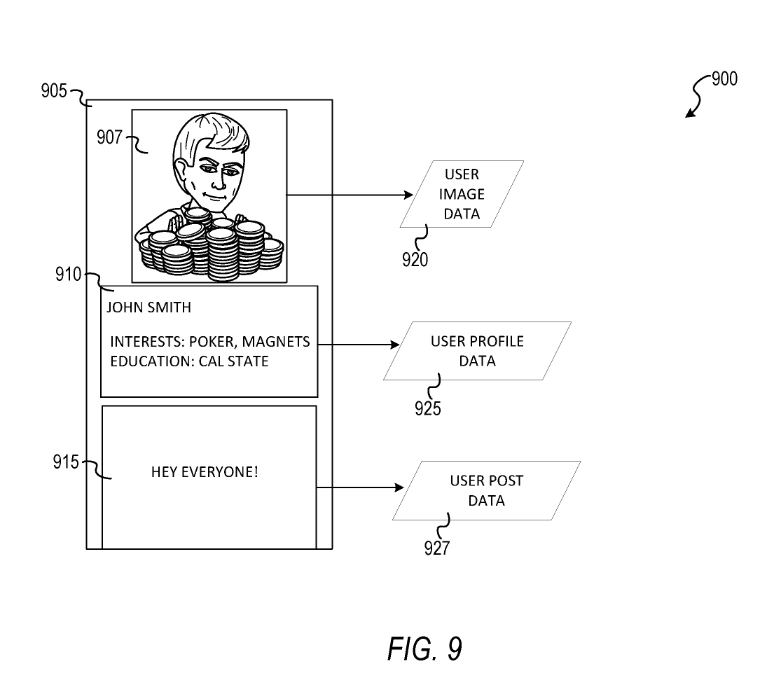

FIG. 9 shows example input data 900 for generating multimodal data, according to some example embodiments. In the example of FIG. 9, a user profile page 905 is a social network site for a given user. The user profile page 905 comprises a user profile image 907, user data 910 (e.g., user name, interests, followers, followees, image albums, etc.), and post data 915 (e.g., posts such as ephemeral messages published by the user). Although the data is displayed as part of profile page, it is appreciated that the data need not be displayed or included in a profile page and that multimodal data can generated for any type of multimodal data. As illustrated, the profile image 907 can be stored as user image data 920, the user data 910 can be stored as user profile data 925, and the post data 915 can be stored as user post data 927, which can then be input into different generates of the modal generator 610 (e.g., a CNN, DNN, LSTM) to generate different modalities, which can be mixed and combined to generate a classification of the user as discussed in FIGS. 7A and 7B.

FIGS. 10A and 10B show example ephemeral messages including content from the multimodal classification system 210, according to some example embodiments. FIG. 10A displays a multimodal ephemeral message 1000 displaying an image 1005 captured by a client device (e.g., an image of a music show/concert) and a caption 1010 input by the user of the client device that describes things depicted in the image. Different modalities of data can be input into the system 210, such as the profile data from the user (FIG. 9), the image 1005, and the caption 1010. The system 210 then mixes modalities and generates a prediction or likelihood that describes whether the user is over or under 45 years of age. In the example of FIGS. 10A and 10B, the image is a of a trap music concert (a type of music popular with younger users). In the example of FIG. 10A, the system 210 generates a prediction that the user is under 45 years old; as such, the content engine 630 can select positive overlay content 1015 on the ephemeral message 1000. In contrast, in the example of FIG. 10B, the system 210 generates a prediction that the user is over 45 years of age, and thus may not like trap music. As such, the content engine 630 selects negative overlay content 1020 on the ephemeral message.

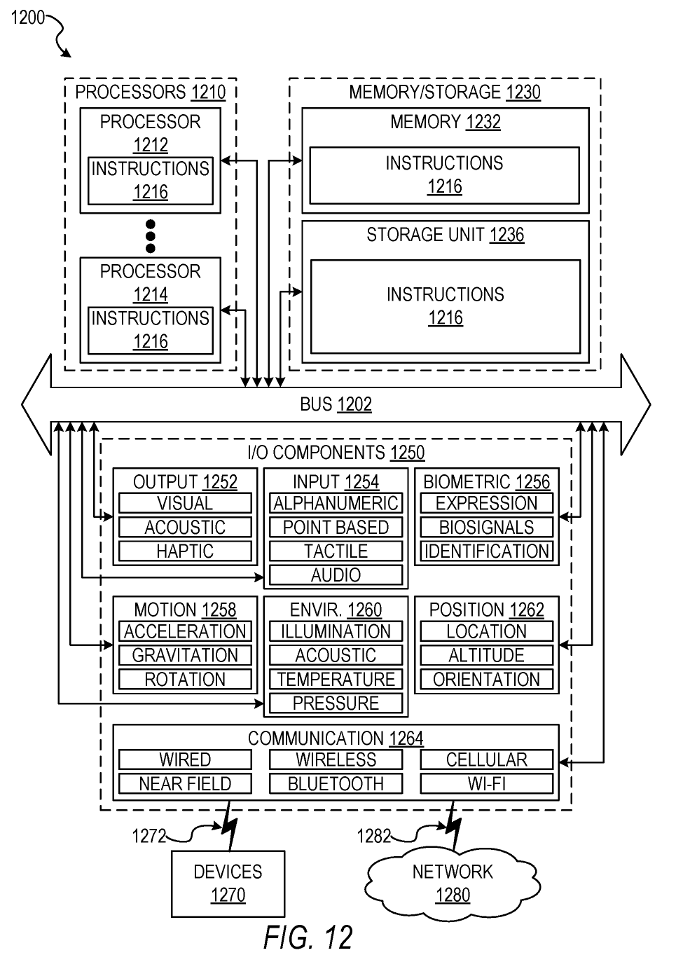

FIG. 11 is a block diagram illustrating an example software architecture 1106, which may be used in conjunction with various hardware architectures herein described. FIG. 11 is a non-limiting example of a software architecture, and it will be appreciated that many other architectures may be implemented to facilitate the functionality described herein. The software architecture 1106 may execute on hardware such as a machine 1110 of FIG. 12 that includes, among other things, processors, memory, and input/output (I/O) components. A representative hardware layer 1152 is illustrated and can represent, for example, the machine 1110 of FIG. 11. The representative hardware layer 1152 includes a processing unit 1154 having associated executable instructions 1104. The executable instructions 1104 represent the executable instructions of the software architecture 1106, including implementation of the methods, components, and so forth described herein. The hardware layer 1152 also includes a memory/storage 1156, which also has the executable instructions 1104. The hardware layer 1152 may also comprise other hardware 1158.

In the example architecture of FIG. 11, the software architecture 1106 may be conceptualized as a stack of layers where each layer provides particular functionality. For example, the software architecture 1106 may include layers such as an operating system 1102, libraries 1120, frameworks/middleware 1118, applications 1116, and a presentation layer 1114. Operationally, the applications 1116 and/or other components within the layers may invoke API calls 1108 through the software stack and receive a response in the form of messages 1112. The layers illustrated are representative in nature and not all software architectures have all layers. For example, some mobile or special-purpose operating systems may not provide a frameworks/middleware 1118, while others may provide such a layer. Other software architectures may include additional or different layers.

The operating system 1102 may manage hardware resources and provide common services. The operating system 1102 may include, for example, a kernel 1122, services 1124, and drivers 1126. The kernel 1122 may act as an abstraction layer between the hardware and the other software layers. For example, the kernel 1122 may be responsible for memory management, processor management (e.g., scheduling), component management, networking, security settings, and so on. The services 1124 may provide other common services for the other software layers. The drivers 1126 are responsible for controlling or interfacing with the underlying hardware. For instance, the drivers 1126 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1120 provide a common infrastructure that is used by the applications 1116 and/or other components and/or layers. The libraries 1120 provide functionality that allows other software components to perform tasks in an easier fashion than by interfacing directly with the underlying operating system 1102 functionality (e.g., kernel 1122, services 1124, and/or drivers 1126). The libraries 1120 may include system libraries 1144 (e.g., C standard library) that may provide functions such as memory allocation functions, string manipulation functions, mathematical functions, and the like. In addition, the libraries 1120 may include API libraries 1146 such as media libraries (e.g., libraries to support presentation and manipulation of various media formats such as MPEG4, H.264, MP3, AAC, AMR, JPG, or PNG), graphics libraries (e.g., an OpenGL framework that may be used to render 2D and 3D graphical content on a display), database libraries (e.g., SQLite that may provide various relational database functions), web libraries (e.g., WebKit that may provide web browsing functionality), and the like. The libraries 1120 may also include a wide variety of other libraries 11411 to provide many other APIs to the applications 1116 and other software components/modules.

The frameworks/middleware 1118 provide a higher-level common infrastructure that may be used by the applications 1116 and/or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1116 and/or other software components/modules, some of which may be specific to a particular operating system 1102 or platform.

The applications 1116 include built-in applications 1138 and/or third-party applications 1140. Examples of representative built-in applications 1138 may include, but are not limited to, a contacts application, a browser application, a book reader application, a location application, a media application, a messaging application, and/or a game application. The third-party applications 1140 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 1140 may invoke the API calls 1108 provided by the mobile operating system (such as the operating system 1102) to facilitate functionality described herein.

The applications 1116 may use built-in operating system functions (e.g., kernel 1122, services 1124, and/or drivers 1126), libraries 1120, and frameworks/middleware 1118 to create user interfaces to interact with users of the system. Alternatively, or additionally, in some systems, interactions with a user may occur through a presentation layer, such as the presentation layer 1111. In these systems, the application/component “logic” can be separated from the aspects of the application/component that interact with a user.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1216 (e.g., software, a program, an application, an applet, an app, or other executable code) for causing the machine 1200 to perform any one or more of the methodologies discussed herein may be executed. As such, the instructions 1216 may be used to implement modules or components described herein. The instructions 1216 transform the general, non-programmed machine 1200 into a machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1216, sequentially or otherwise, that specify actions to be taken by the machine 1200. Further, while only a single machine 1200 is illustrated, the term “machine” shall also be taken to include a collection of machines that individually or jointly execute the instructions 1216 to perform any one or more of the methodologies discussed herein.

The machine 1200 may include processors 1210, memory/storage 1230, and I/O components 1250, which may be configured to communicate with each other such as via a bus 1202. The memory/storage 1230 may include a memory 1232, such as a main memory, or other memory storage, and a storage unit 1236, both accessible to the processors 1210 such as via the bus 1202. The storage unit 1236 and memory 1232 store the instructions 1216 embodying any one or more of the methodologies or functions described herein. The instructions 1216 may also reside, completely or partially, within the memory 1232, within the storage unit 1236, within at least one of the processors 1210 (e.g., within the processor cache memory accessible to processor units 1212 or 1214), or any suitable combination thereof, during execution thereof by the machine 1200. Accordingly, the memory 1232, the storage unit 1236, and the memory of the processors 1210 are examples of machine-readable media.

The I/O components 1250 may include a wide variety of components to receive input, provide output, produce output, transmit information, exchange information, capture measurements, and so on. The specific I/O components 1250 that are included in a particular machine 1200 will depend on the type of machine. For example, portable machines such as mobile phones will likely include a touch input device or other such input mechanisms, while a headless server machine will likely not include such a touch input device. It will be appreciated that the I/O components 1250 may include many other components that are not shown in FIG. 12. The I/O components 1250 are grouped according to functionality merely for simplifying the following discussion and the grouping is in no way limiting. In various example embodiments, the I/O components 1250 may include output components 1252 and input components 1254. The output components 1252 may include visual components (e.g., a display such as a plasma display panel (PDP), a light-emitting diode (LED) display, a liquid-crystal display (LCD), a projector, or a cathode ray tube (CRT)), acoustic components (e.g., speakers), haptic components (e.g., a vibratory motor, resistance mechanisms), other signal generators, and so forth. The input components 1254 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1250 may include biometric components 1256, motion components 1258, environment components 1260, or position components 1262 among a wide array of other components. For example, the biometric components 1256 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1258 may include acceleration sensor components (e.g., accelerometer), gravitation sensor components, rotation sensor components (e.g., gyroscope), and so forth. The environment components 1260 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 1262 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1250 may include communication components 1264 operable to couple the machine 1200 to a network 1280 or devices 1270 via a coupling 1282 and a coupling 1272, respectively. For example, the communication components 1264 may include a network interface component or other suitable device to interface with the network 1280. In further examples, the communication components 1264 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1270 may be another machine or any of a wide variety of peripheral devices (e.g., a peripheral device coupled via a USB).

Moreover, the communication components 1264 may detect identifiers or include components operable to detect identifiers. For example, the communication components 1264 may include radio frequency identification (RFID) tag reader components, NFC smart tag detection components, optical reader components (e.g., an optical sensor to detect one-dimensional barcodes such as Universal Product Code (UPC) barcode, multi-dimensional barcodes such as Quick Response (QR) code, Aztec code, Data Matrix, Dataglyph, MaxiCode, PDF418, Ultra Code, UCC RSS-2D barcode, and other optical codes), or acoustic detection components (e.g., microphones to identify tagged audio signals). In addition, a variety of information may be derived via the communication components 1264, such as location via Internet Protocol (IP) geolocation, location via Wi-Fi® signal triangulation, location via detecting an NFC beacon signal that may indicate a particular location, and so forth.

### Glossary

“CARRIER SIGNAL” in this context refers to any intangible medium that is capable of storing, encoding, or carrying instructions 1216 for execution by the machine 1200, and includes digital or analog communications signals or other intangible media to facilitate communication of such instructions 1216. Instructions 1216 may be transmitted or received over the network 1280 using a transmission medium via a network interface device and using any one of a number of well-known transfer protocols.

“CLIENT DEVICE” in this context refers to any machine 1200 that interfaces to a communications network 1280 to obtain resources from one or more server systems or other client devices 102. A client device 102 may be, but is not limited to, a mobile phone, desktop computer, laptop, PDA, smartphone, tablet, ultrabook, netbook, multi-processor system, microprocessor-based or programmable consumer electronics system, game console, set-top box, or any other communication device that a user may use to access a network 1280.

“COMMUNICATIONS NETWORK” in this context refers to one or more portions of a network 1280 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network 1280 may include a wireless or cellular network and the coupling may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

“EMPHEMERAL MESSAGE” in this context refers to a message 400 that is accessible for a time-limited duration. An ephemeral message 502 may be a text, an image, a video, and the like. The access time for the ephemeral message 502 may be set by the message sender. Alternatively, the access time may be a default setting or a setting specified by the recipient. Regardless of the setting technique, the message 400 is transitory.

“MACHINE-READABLE MEDIUM” in this context refers to a component, a device, or other tangible media able to store instructions 1216 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EPROM)), and/or any suitable combination thereof. The term “machine-readable medium” should be taken to include a single medium or multiple media (e.g., a centralized or distributed database, or associated caches and servers) able to store instructions 1216. The term “machine-readable medium” shall also be taken to include any medium, or combination of multiple media, that is capable of storing instructions 1216 (e.g., code) for execution by a machine 1200, such that the instructions 1216, when executed by one or more processors 1210 of the machine 1200, cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, a physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor 1212 or a group of processors 1210) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine 1200) uniquely tailored to perform the configured functions and are no longer general-purpose processors 1210. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein.

Considering embodiments in which hardware components are temporarily configured (e.g., programmed), each of the hardware components need not be configured or instantiated at any one instance in time. For example, where a hardware component comprises a general-purpose processor 1212 configured by software to become a special-purpose processor, the general-purpose processor 1212 may be configured as respectively different special-purpose processors (e.g., comprising different hardware components) at different times. Software accordingly configures a particular processor 1212 or processors 1210, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between or among such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors 1210 that are temporarily configured (e.g., by software) or permanently configured to perform the relevant operations. Whether temporarily or permanently configured, such processors 1210 may constitute processor-implemented components that operate to perform one or more operations or functions described herein. As used herein, “processor-implemented component” refers to a hardware component implemented using one or more processors 1210. Similarly, the methods described herein may be at least partially processor-implemented, with a particular processor 1212 or processors 1210 being an example of hardware. For example, at least some of the operations of a method may be performed by one or more processors 1210 or processor-implemented components. Moreover, the one or more processors 1210 may also operate to support performance of the relevant operations in a “cloud computing” environment or as a “software as a service” (SaaS). For example, at least some of the operations may be performed by a group of computers (as examples of machines 1200 including processors 1210), with these operations being accessible via a network 1280 (e.g., the Internet) and via one or more appropriate interfaces (e.g., an API). The performance of certain of the operations may be distributed among the processors 1210, not only residing within a single machine 1200, but deployed across a number of machines 1200. In some example embodiments, the processors 1210 or processor-implemented components may be located in a single geographic location (e.g., within a home environment, an office environment, or a server farm). In other example embodiments, the processors 1210 or processor-implemented components may be distributed across a number of geographic locations.

“PROCESSOR” in this context refers to any circuit or virtual circuit (a physical circuit emulated by logic executing on an actual processor 1212) that manipulates data values according to control signals (e.g., “commands,” “op codes,” “machine code,” etc.) and which produces corresponding output signals that are applied to operate a machine 1200. A processor may, for example, be a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC), or any combination thereof. A processor 1210 may further be a multi-core processor 1210 having two or more independent processors 1212, 1214 (sometimes referred to as “cores”) that may execute instructions 1216 contemporaneously.

“TIMESTAMP” in this context refers to a sequence of characters or encoded information identifying when a certain event occurred, for example giving date and time of day, sometimes accurate to a small fraction of a second.

What is claimed is:

1. A method comprising:
identifying a multimodal dataset of a data item;
generating multimodal vectors in different modalities from the multimodal dataset using different machine learning schemes;
generating a classification of the data item from a neural network trained to select informative vectors of the multimodal vectors; and
storing the classification of the data item.

2. The method of claim 1, wherein generating the classification using the neural network comprises multiplicatively combining the multimodal vectors to select the informative vectors.

3. The method of claim 2, wherein multiplicatively combining the multimodal vectors nulls non-informative vectors of the multimodal vectors.

4. The method of claim 1, wherein generating the classification using the neural network comprises generating candidate mixtures by additively combining the multimodal vectors.

5. The method of claim 1, wherein the selected informative vectors include one or more of the generated candidate mixtures.

6. The method of claim 1, wherein the data item is a user of a network site and the multimodal dataset comprises different types of user data of the user.

7. The method of claim 1, wherein the machine learning schemes include one or more of: a convolutional neural network, a recurrent neural network, a bidirectional recurrent neural network, a fully connected neural network.

8. The method of claim 1, further comprising:
selecting display content from the classification of the data item.

9. The method of claim 8, further comprising:
publishing an ephemeral message that includes the display content on a network site.

10. A system comprising:
one or more processors of a machine; and
a memory storing instructions that, when executed by the one or more processors, cause the machine to perform operations comprising:
identifying a multimodal dataset of a data item;
generating multimodal vectors in different modalities from the multimodal dataset using different machine learning schemes;
generating a classification of the data item from a neural network trained to select informative vectors of the multimodal vectors; and
storing the classification of the data item.

11. The system of claim 10, wherein generating the classification using the neural network comprises multiplicatively combining the multimodal vectors to select the informative vectors.

12. The system of claim 11, wherein multiplicatively combining the multimodal vectors nulls non-informative vectors of the multimodal vectors.

13. The system of claim 10, wherein generating the classification using the neural network comprises generating candidate mixtures by additively combining the multimodal vectors.

14. The system of claim 10, wherein the selected informative vectors include one or more of the generated candidate mixtures.

15. The system of claim 10, wherein the data item is a user of a network site and the multimodal dataset comprises different types of user data of the user.

16. The system of claim 10, wherein the machine learning schemes include one or more of: a convolutional neural network, a recurrent neural network, a bidirectional recurrent neural network, a fully connected neural network.

17. The system of claim 10, the operations further comprising:
selecting display content from the classification of the data item.

18. The system of claim 17, the operations further comprising:
publishing an ephemeral message that includes the display content on a network site.

19. The system of claim 10, wherein generating the classification using the neural network comprises multiplicatively combining the multimodal vectors to select the informative vectors.

20. A machine-readable storage device embodying instructions that, when executed by a machine, cause the machine to perform operations comprising:
identifying a multimodal dataset of a data item;
generating multimodal vectors in different modalities from the multimodal dataset using different machine learning schemes;
generating a classification of the data item from a neural network trained to select informative vectors of the multimodal vectors; and
storing the classification of the data item.
